(19) United States
(12) Patent Application Publication
(10) Pub. No.: US 2023/0137180 A1
(43) Pub. Date: May 4, 2023

(54) System and Method for Generating Legal Contracts

(71) Applicants: William Robert Moriarty, Pasadena, CA (US); Gina Pak, Pasadena, CA (US); Andrew Wells, Dallas, TX (US); Scott Tamura, Gardena, CA (US)

(72) Inventors: William Robert Moriarty, Pasadena, CA (US); Gina Pak, Pasadena, CA (US); Andrew Wells, Dallas, TX (US); Scott Tamura, Gardena, CA (US)

(21) Appl. No.: 18/088,728

(22) Filed: Dec. 26, 2022

Related U.S. Application Data
(63) Continuation-in-part of application No. 16/900,957, filed on Jun. 14, 2020.
(60) Provisional application No. 62/861,790, filed on Jun. 14, 2019.

(51) Int. Cl. G06Q 50/18

(52) U.S. Cl. CPC G06Q 50/182; G06F 3/04847

(57) ABSTRACT

A machine-learning-based method for analyzing, negotiating, and drafting contracts that provides the user with information regarding market terms for particular industries and geographic locations.

### CROSS-REFERENCE TO RELATED APPLICATIONS

The present application is a continuation in part of application Ser. No. 16/900,957, filed Jun. 14, 2020, which takes priority from Provisional App. No. 62/861,790, filed Jun. 14, 2019, which are both incorporated herein by reference.

### BACKGROUND

### Field of the Invention

The present invention relates generally to systems, methods, and software for generating and reviewing documents, and specifically to systems, methods, and software for generating and reviewing legal contracts.

### Background of the Invention

A large part of a legal professional's work is generating, reviewing and negotiating transactional documents such as contracts. Typically, a contract includes many provisions that may favor one side over another, and lawyers for each side must recognize, understand, and negotiate each provision during the negotiation process for the agreement. This is often a cumbersome process and requires extensive expertise and resources.

Existing document automation systems can elicit data from a user to generate a document. For example, a user can select the type of document, enter the names of the parties, and enter some other types of data, and generate a document of the desired type based on the user inputs.

Some document automation systems can use rules to generate documents based on the input data; for example, a party that is a corporation may be treated differently from a party who is a natural person, and the contract may be worded differently depending on the nature of the party. Another example would be using an iterative process to generate a list of parties, or to insert a particular phrase repeatedly for each party in a contract.

One thing that existing document automation systems do not do, however, is provide a user with any guidance about the way things are typically done in a particular industry or a particular type of agreement or for a particular type of party. While an experienced contract drafter may be aware of common industry practices in their industry, a novice may not be, and the novice may find themselves at a disadvantage during negotiations because of that.

Another thing that existing document automation systems do not do is provide a user with guidance as to clause language that is more or less favorable to a particular party. For example, during negotiations, a contract drafter may want to alter the language of a clause to make it more favorable to a particular party. Existing document automation systems do not determine the favorability of a clause, and thus would not be able to determine how to change a clause to make it more favorable.

A need exists for a document automation system that can provide a user with guidance based on common practices in a particular market, and with information regarding the favorability of a particular clause.

### LIST OF FIGURES

FIG. 1 shows a diagram of an embodiment of the system of the present invention.

FIG. 2 shows a flowchart of an embodiment of the method of the present invention.

FIG. 3 shows a sample screenshot from an embodiment of the present invention.

FIG. 4A shows a sample screenshot from an embodiment of the present invention.

FIG. 4B shows a sample screenshot from an embodiment of the present invention.

FIG. 5A shows a sample screenshot from an embodiment of the present invention.

FIG. 5B shows a sample screenshot from an embodiment of the present invention.

FIG. 5C shows a sample screenshot from an embodiment of the present invention.

FIG. 5D shows a sample screenshot from an embodiment of the present invention.

### SUMMARY OF THE INVENTION

An object of the present invention is to provide a system and method for analyzing, generating, and negotiating contracts.

Another object of the present invention is to use machine learning to analyze, generate, and negotiate contracts.

Another object of the present invention is to identify and collect data from user inputs related to contract type, industry, compensation, duties, and favorability, and to use the collected data to augment and improve the machine learning models.

Another object of the present invention is to identify and collect data from user inputs related to contract type, industry, compensation, duties, and favorability, and to use the collected data to provide a user with guidance regarding common practices in the particular contract type, industry, or for a particular type of party.

Another object of the present invention is to provide a system and method for adjusting the favorability of a particular provision of a contract.

An aspect of the present invention is a method for generating legal documents comprising at least one clause. Such legal documents may be contracts or other transactional documents. The method may include selecting a legal document type, selecting at least one parameter, such as client industry, geographic location, client's point of view, and automatically generating a legal document using the at least one parameter; then, displaying the legal document on a display device and presenting the user with a selection interface wherein a user can select alternative versions of at least one particular clause. The selection interface presents the user with information on the legal impact of each alternative version, such as the favorability of the version to a given party, and with recommendations based on common practices in that particular industry, contract type, or for this particular type of party.

In an aspect of the invention, the user's selections are recorded, aggregated with other users' selections, and anonymized, and used to generate statistical data related to common practices in the particular industry, contract type, or type of party. The statistical data is then used to generate recommendations to subsequent users.

In an aspect of the invention, the selection interface provides the user with at least two versions of a clause and information on the favorability of each of these versions to a party.

Variations in these and other aspects will be described in additional detail hereafter.

### DETAILED DESCRIPTION OF EXEMPLARY EMBODIMENTS

Before embodiments of the present invention are described in detail, it is to be understood that the description is not meant to be limiting, and that the invention is not limited in its application to the details of the construction and components set forth in the description or illustrated in the drawings. It is also to be understood that the phraseology and terminology used herein is for the purposes of description and not meant to be limiting.

While the following detailed description discloses the application of the present invention to drafting legal contracts and agreements, and refers to clauses of said contracts, the present invention may be used for other standardized documents comprising multiple clauses where information from multiple users may be aggregated to give a subsequent user guidance on how the document is to be drafted.

Overview of the System

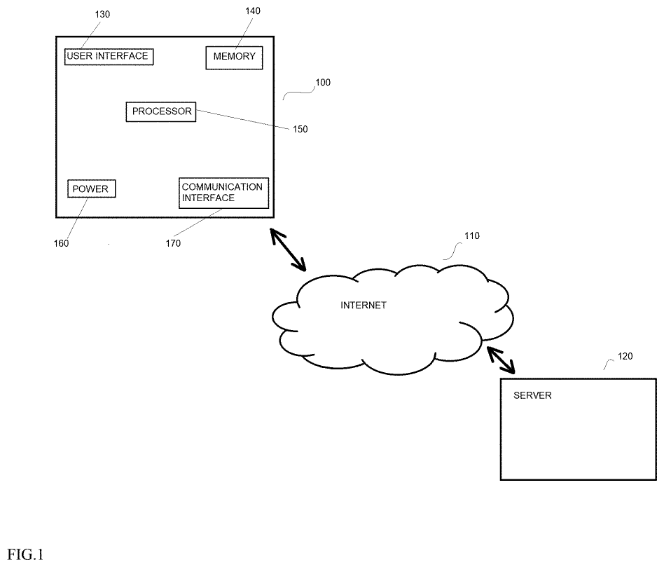

The present invention is implemented on a computing device. FIG. 1 shows a computing device 100 in accordance with an aspect of the present invention. The computing device 100 preferably comprises a processor, a memory, a communication interface, a user interface, and a power supply. The communication interface is preferably connected to a server 120 by means of the Internet 110 or some other data/communications network. The computing device can be a computer, a tablet, a smartphone, or any other device that can execute the methods of the present invention.

Workflow

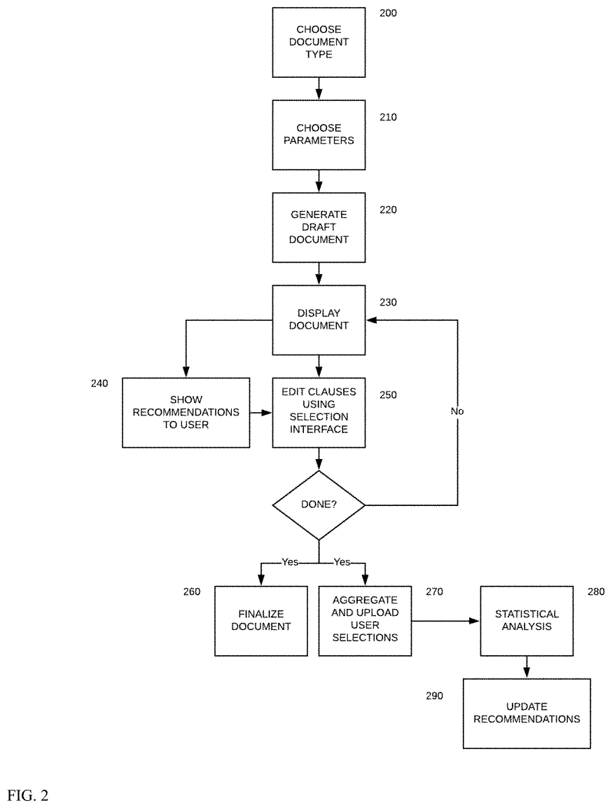

FIG. 2 shows a flowchart illustrating processes performed in accordance with an embodiment of the present invention. A user first chooses a document type 200. For example, a document type may be a services agreement, a nondisclosure agreement, a statement of work, a privacy policy, a nondisclosure agreement, terms of use, employee offer letter, employment agreement, licensing agreement, LLC operating agreement, or any other contract or agreement. The document may involve only a single party (i.e. a nondisclosure agreement), or two or more parties (i.e. a services agreement between a service provider and a client). It is to be understood that the document type is not limited to the types disclosed above, but may be any standardized document comprising multiple clauses.

As the user chooses the type of document, it is assigned a corresponding data tag. Going forward, each selection by the user results in a data tag being added to the document. After the contract is created, all those tags are then aggregated with other users' selections and used to generate statistical recommendations for other users.

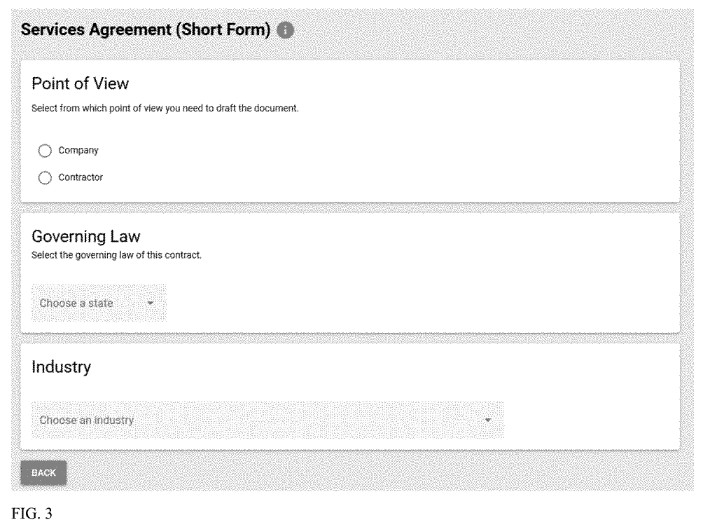

After the user selects the document type, they then choose the parameters 210 for that document. In an embodiment, the parameters may be the client industry, geographical location, the point of view (i.e. service provider or client), or any other parameters affecting the document. FIG. 3 shows a screenshot of the embodiment of the present invention where the user is prompted to choose the parameters. In the preferred embodiment, there are 14 general industry tags, though the present invention is not limited to that particular number. The point of view, for purposes of the present invention, is the identity of the party drafting the contract. For example, a contract written from the point of view of the service provider would look different from a contract written from the client's point of view. Each one of those parameters has a tag assigned to it; these tags are then collected and used to generate a draft document 220.

The draft document is then displayed for the user 230. The draft document is assembled from a clause database corresponding to the tags selected by the user. The clause database comprises a collection of contract clauses. In an embodiment, the contract clauses are organized into modules depending on what type of clause they are. In an embodiment, the modules are:
a. Bespoke clauses (where the majority of the language would later be modified by the user)—i.e. the clause consists mostly of a description of the required content within bracketed language.
b. Boilerplate clauses, where the language is unlikely to be changed by the user after it is generated.
c. Mechanical language clauses, wherein the clause language has a set number of options or positions. Those clauses can be divided into two categories:
   i. Structural clauses are clauses that are generated with multiple options that the user can choose from based on the facts of their situation to vary the specifics of the language. For example, the term of the contract can be selected from “auto-renewal”, “ends with performance”, or “ends on a specific date”.
      ii. Favorability clauses are clauses that are generated with multiple options that the user can choose from based on negotiating power/parity of the parties to vary the degree of the language. For example, an indemnification clause can be “least favorable”, “less favorable”, “neutral”, “more favorable”, or “less favorable”. It must be noted that the favorability of a clause is depending on the point of view of the contract—a clause that is less favorable would be more favorable to the other party.

Each module has specific tags associated with it which dictate whether or not it should be added to a generated document. Those tags correspond to the user inputs, such as point of view, location, or industry, as well as where the clause module should be located within the generated document and whether it has any additional positions (like the mechanical language clauses).

Each clause of the document is presented in an editable interface; the type of editable interface depends on what kind of clause it is.

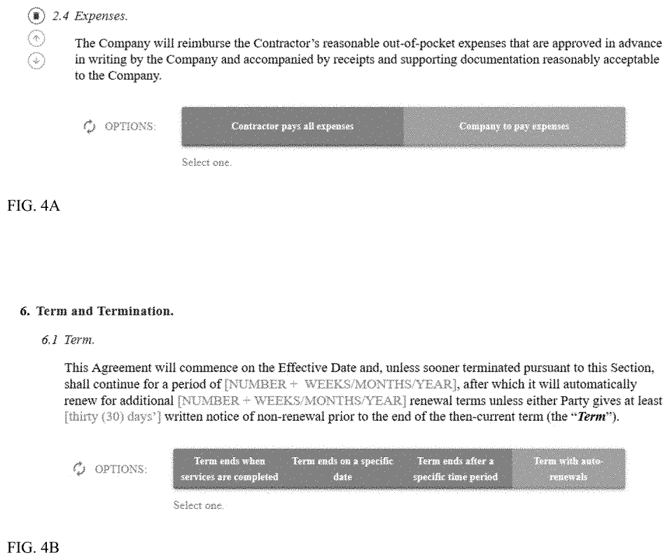

In an embodiment, a clause may be editable by clicking a button (this is good for structural clauses where a user can select one of several options). FIGS. 4A and 4B show examples of buttons that can adjust the form of a clause from one option to another. For example, FIG. 4A shows a clause regarding a contractor's expenses. A user may choose between “Contractor pays all expenses” and “Company to pay expenses”. Clicking each button will change the text of the clause in accordance with the button.

In an embodiment, a clause may be editable both by clicking a button and by entering text (this is good for bespoke clauses, where a user will need to enter text). FIG. 4B shows a clause regarding the term of an agreement. A user may choose four options for the term, and enter text directly into the clause as well, as shown in the Figure.

It will be understood that any number of buttons may be used to practice the present invention, and that any clause may be edited by means of buttons as shown.

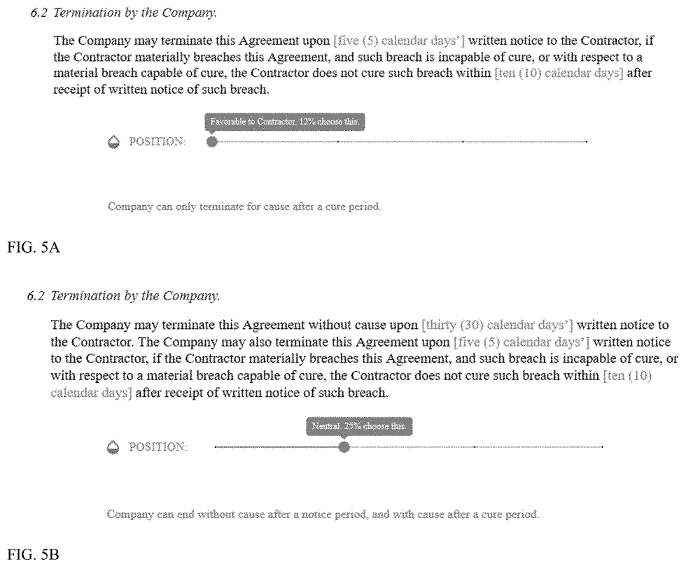

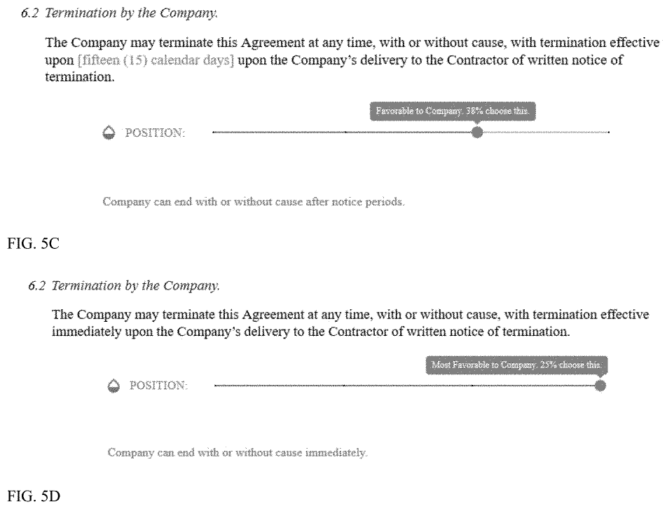

In an embodiment, a clause may be editable by sliding a slider; this is useful for favorability clauses. The present invention offers a user an easy way to adjust the favorability of various clauses using a selection interface. FIGS. 5A-5D show four versions of a termination clause, in order from the most favorable to the contractor (FIG. 5A), to the most favorable to the company (FIG. 5D). It will be understood that any number of versions of a particular clause may be used with the present invention.

As the user makes their selections and edits each clause, the system of the present invention tracks their interactions with the document; for example, text language edits, formatting changes, and mechanical language position choices are tracked and added to each clause module as additional tags. For example: Service Agreement—POV: company/Location: Ohio/Industry: manufacturing++indemnification: Most favorable/Termination notice bracketed language [30 days]. All of this information is added as annotations to the clause module data to better fit real-world standards and to help other users understand how and where each clause is being used and how it is being edited. Each interaction further refines the module to the best language for a particular situation.

The initial tags for the clause modules follow the general rubric—Clause Type (Bespoke/Boilerplate/Mechanical)/Area/Topic/Contract Type—before logging the initial user inputs—Source POV/Location/Industry. In an embodiment, additional labels may also be used for different clause modules. The below table shows an embodiment of some of those labels:

TABLE 1

| | | | | | |
|---|---|---|---|---|---|
| [symbol] | [symbol] | [symbol] | [symbol] | [symbol] | [symbol] |

| | | | |
|---|---|---|---|
| Information Collected Automatically | | Subtype 1 | |
| Information from Other Sources | | Subtype 1 | |
| Information Provided by User | | Subtype 1 | |
| Informed Consent (Acknowledgement) | Acknowledgements | Primary Label | Stock Purchase Agreement |
| Infringement Claim | Claim of Infringement | Primary Label | Cease & Desist |
| Inspection of Facilities | | Subtype 1 | Covenants |
| Inspection of Goods | | Subtype 1 | |
| Inspection Rights | | Primary Label | Accounting Matters |
| Inspectors at Meetings | | Subtype 1 | Business Formation \| Meetings |
| Instant Messenging Usage | | Subtype 1 | Employee Handbook \| Electronic |
| | | | Resources and IT Communications Policy |
| Insurance | | Primary Label | |
| Intellectual Property (Compliance) | | Subtype 1 | Employee Handbook \| Electronic |
| | | | Resources and IT Communications Policy |
| Intellectual Property ( [symbol] &W) | | Subtype 2 | |
| Intellectual Property Rights | No Transfer of rights, | Primary Label | |
| | Title or Interest | | |
| Interest- [symbol] Advertising | | Subtype 1 | Promissory Notes \| Repayments |
| Interest Payments | | Subtype 1 | Employee Handbook \| Electronic |
| | | | Resources and IT Communications Policy |
| Internet Usage | | Subtype 1 | |
| Interpretation | Headings | Primary Label | |
| Investment Experience (R&W) | | Subtype 2 | |
| Invoices | | Subtype 1 | |
| Inv [symbol] Transfer | | Primary Label | Stock Purchase Agreement |
| [symbol] | | Subtype 1 | [symbol] |

[symbol]

indicates data missing or illegible when filed

As the user interacts with the draft document, their interactions are tracked. In an embodiment of the invention, the following interactions are tracked:

a. Mechanical Language Selections (situations and favorability)
b. Text bracketed edits
c. Heatmaps (where users spend time on the document)
d. Download the completed document or restart
e. Copy to clipboard

Each of those interactions is then saved as a tag for the clause in question and aggregated for statistical analysis. The system can then apply filters and a time frame to understand how users interact with a particular clause or set of clauses. For example, the filter can be: “Service Agreements—POV: Company—State: California—Industry: Healthcare—Mechanical Language: Indemnity—12/1/2021-Present”, and the output will then be: “10,000 documents—Least favorable=10%/Less Favorable=25% —Neutral=50%/More Favorable=5%/Most favorable=10%”. The data can then be given to the users or used for further analysis.

As can be seen in FIGS. 5A-5D, the present invention also offers guidance to a user on the percentage of all users that select each option, and shows recommendations 240 to the user during the editing process. The statistics are generated by the system from aggregating the selections made by multiple prior users, and presented to the user to inform their choice. A user is then able to make an informed choice in line with common practices.

As can be seen in FIGS. 5A-5D, one other way the present invention offers guidance to the user is by explaining what the legal impact of each clause is. For example, FIG. 5A offers an explanation of the clause under the slider as “Company can only terminate for cause after a cure period.” Each one of FIGS. 5B, 5C, and 5D also offer explanations of each version of the clause. This further helps guide the user into making informed choices on behalf of their client.

In an embodiment, user selections are used to train a machine learning system for text classification or other natural language processing applications. The machine learning system can then generate better initial drafts and recommendations for the user, or be used for natural language processing applications in the legal field in general. In an embodiment, the system uses basic statistical modeling to show other users the percentage of users that do a particular action (e.g. Indemnification—45% choose the neutral option and 12% choose the most favorable option).

If a user is done, the document is finalized 260. The user's selections (the buttons the user clicked, numerical values that are entered, or slider positions for favorability) are anonymized, aggregated, and uploaded to the server 120. The server then performs a statistical analysis 280 on the aggregated data and updates the recommendations 290 for subsequent users.

Market Standards and Recommendations

As can be seen in FIGS. 5A-5D, the user is presented with information regarding best practices and market standards related to the particular type of clause and particular type of contract. In the presently described embodiment, for each position of the slider, the user is presented with the percentage of all users that choose that position. For example, in FIG. 5A, the user is informed that 12% choose the position selected in the Figure; in FIG. 5B, the user is informed that 25% choose the position selected; in FIG. 5C, the user is informed that 38% choose the position selected; and in FIG. 5D, the user is informed that 25% choose the position selected. The information is generated by aggregating and analyzing selections made by other users, or other selections made by the same user.

In an aspect of the present invention, contracts are grouped by industry, type of contract, client POV, client's industry, and/or geographical location. The statistical analysis is then performed for each group, so that the recommendations to the user can come from an analysis of the same type of contract as the one the user is drafting, in the same geographical area and industry that the user is in. Since standards differ by industry and geographical area, this is very helpful for a user and provides useful information. For example, the statistical analysis may determine what percentage of indemnification clauses in the food processing industry in California favor the contractor over the corporation, or what the typical royalty rate is for a patent licensing agreement in Nevada in the gambling industry.

In an aspect of the present invention, as the user makes certain selections for different clauses (i.e. using the buttons or the sliders to pick particular versions of given clauses, making in document substantive edits, or filling in data for durations or fees or other alphanumerical information), the user's selections are recorded and a pattern is generated. The pattern can comprise user selections or alphanumerical values. The pattern may be plaintext or assigned weighted number or symbol, and may be in any other format that can represent the information required. In an aspect of the present invention, the pattern may be displayed to the user.

The pattern for the user is then uploaded to a server 120 via the Internet 110 or another communication interface, as shown in FIG. 1. The pattern is aggregated 270 with other patterns uploaded by other users. A statistical analysis 280 is then performed on the patterns.

The statistical analysis is preferably geared to determine market standards for particular contract clauses for particular types of contracts, particular industries, and particular geographic areas, and may include contract type, client POV, clause type, industry, geographic location, or any combination of the above variables.

In an embodiment, the statistical information is analyzed at several points in time (at least three) over a period of at least six months. The system then generates a plot of the data and determines if there are any trends.

After the statistical analysis is performed, the data is then used to make recommendations 290 for a future user. For example, a user who is generating a contract in a particular industry and a particular geographical location will get recommendations based on what other users in the same industry and the same geographical locations have selected (i.e. “92% of users in Nevada who are generating a casino employment agreement have selected an indemnification clause that favors the employer”). The recommendations may be triggered to pop up at the time when a user is editing or generating a particular clause of the contract, may be summarized for the user when the user selects the type of contract, industry, and geographical location, or may be presented to the user after they make their selections, before they finalize the contract.

In an embodiment, the system of the present invention is a machine learning system. The system preferably comprises a hierarchical system of using artificial neural networks including, but not limited to, convolutional neural networks (CNN's), recurrent neural networks (RNNs), Long term short-memory RNNs (LSTMs), and machine learning models including but not limited to statistical probability models, linear regression models, clustering, naive Bayesian, support-vector models (svg) models trained using a feedback loop of supervised learning and rule-based pattern matching, and any reasonable equivalents to the above. The system may also use supervised learning, which consists of presenting the model with pre-labeled data to build a feature space representation. The final platform output preferably consists of multiple classifications including document type, clause classification, and clause favorability.

In an embodiment, the user interaction tags in the clause module data may be used as an annotated data set to be used as training data for legal text classification and chunking Natural Language Processing (NLP) needs.

In an embodiment, the user interaction tags may be used to predict contract trends and market changes for different locations or industries. If there is sufficient data from enough users over a period of time, future actions may be predicted based on historical trends. For example, a particular type of clause may be less favorable now than it was 10 years ago, or the term of a particular type of agreement may be getting shorter.

In an embodiment, the user interaction tags may be used to provide decision support and automatic comment generation on documents. Tracking and aggregating multiple users' interactions with conditional logic checklists for generating a particular type of contract may be used to train a CNN on what conditional logic steps can be skipped by a user when following a decision tree for particular contract language.

An exemplary embodiment is described above. It will be understood that the present invention encompasses other embodiments whose elements form reasonable equivalents to the embodiments described above.

1. A method for generating contracts between at least two parties, wherein the contract is an agreement between a first party and a second party, said contract comprising at least one clause, comprising:
selecting a contract type for the contract to be generated out of at least two types of contracts;
selecting at least one parameter for the contract to be generated;
adding at least one initial tag corresponding to the at least one parameter to a database entry for the contract to be generated;
selecting a plurality of clauses from a clause database, wherein each of the plurality of clauses corresponds to the at least one initial tag;
generating a draft contract comprising the plurality of clauses;
displaying the draft contract on a display device;
for at least one clause of the plurality of clauses, presenting a selection interface wherein a user can select alternative versions of the clause, wherein the selection interface presents the user with information on a legal impact of each of the alternative versions and statistical data on selections made by a plurality of users;
for at least one clause, recording a user selection relative to the at least one clause;
using a computing device to generate a final version of the contract based on user selections;
downloading the final version of the contract;
aggregating the selections made by the user and adding them to the statistical data.

2. The method of claim 1, wherein recording a user selection relative to the at least one clause comprises adding a tag to a database entry for the clause.

3. The method of claim 1, wherein the at least one parameter is selected from a list comprising: client industry, client's geographic location, client's point of view.

4. The method of claim 1, wherein the legal impact of each alternative version comprises a favorability of each clause to at least one of the following: a first party, a second party.

5. The method of claim 1, wherein the selection interface comprises at least one of the following: an interactive slider, buttons, text entry fields.

6. The method of claim 1, further comprising:
using the statistical data to train a natural language processing system.

7. The method of claim 1, further comprising:
using the statistical data to analyze trends.

8. The method of claim 1, further comprising:
using the statistical data to generate recommendations to a second user using a machine learning algorithm.

9. A system for generating a contract comprising at least one clause, wherein the contract is an agreement between a first party and a second party, comprising:
a server comprising a database, wherein the database comprises at least one contract clause and at least one tag associated with each of the at least one contract clause;
a computing device connected to the server, wherein the computing device comprises:
a processor;
a display device;
a user interface;
a memory, wherein the memory includes instructions executable by the processor to:
select a contract type for a contract to be generated out of at least two types of contracts;
select at least one parameter for the contract to be generated;
automatically generate the contract using the at least one parameter;
display the contract on the display device;
for at least one clause, present a selection interface wherein a user can select alternative versions of the clause with the user interface, wherein the selection interface presents the user with information on a legal impact of each of the alternative versions and statistical data on selections made by a plurality of users;
record the selections made by the user;
generate a final version of the contract based on user selections;
download the final version of the contract;
aggregate the selections made by the user and add them to the statistical data.

10. The system of claim 9, wherein the at least one parameter is selected from a list comprising: client industry, client's geographic location, whether the client is the first party or the second party.

11. The system of claim 9, wherein the selections made by the user comprise at least one of:
version of the clause selected;
text entered into a clause;
amount of time spent on each clause.

12. The system of claim 9, wherein the legal impact of each alternative version comprises a favorability of each clause to at least one of the following: the first party, the second party.

13. The system of claim 9, wherein the statistical data comprises:
popular selections in a particular market, wherein the market comprises at least one of:
particular contract types, client's industry, client's geographic location.

14. The system of claim 9, wherein the selection interface comprises at least one of the following: an interactive slider, at least one interactive button, a text entry field.

15. The system of claim 9, wherein the statistical data comprises recommendations to the user.

16. The system of claim 15, wherein the recommendations to the user are generated using machine learning algorithms.

17. The system of claim 9, wherein the statistical data is used to train a natural language processing system.

18. The system of claim 9, wherein the statistical data is used to analyze trends.
